(19) United States
(12) Patent Application Publication
(10) Pub. No.: US 2026/0313583 A1
(43) Pub. Date: Oct. 8, 2026

(54) METHOD TO HANDLE REGISTRATION AND DEREGISTRATION OF AUTHENTICABLE NON-3GPP DEVICES BEHIND 5G-RG

(71) Applicant: Telefonaktiebolaget LM Ericsson (publ), Stockholm (SE)

(72) Inventors: Kamran Keykhosravi, Göteborg (SE); Stefan Rommer, Västra Frölunda (SE); Yumei Song, Göteborg (SE)

(21) Appl. No.: 19/481,402

(22) PCT Filed: May 8, 2024
(86) PCT No.: PCT/IB2024/054501

§ 371 Date: Nov. 4, 2025

Related U.S. Application Data
(60) Provisional application No. 63/464,991, filed on May 9, 2023.

(51) Int. Cl. H04W 60/06; H04W 12/06; H04W 76/30

(52) U.S. Cl. CPC H04W 60/06; H04W 12/06; H04W 76/30

(57) ABSTRACT

Various embodiments disclosed herein provide for a method performed by a Wireline Access Gateway Function (W-AGF) for handling registration and connection to a core network of one or more Authenticable Non-Third Generation Partnership Program (3GPP) (AUN3) devices behind a residential gateway (RG) connected with a line to the W-AGF. The method includes receiving from the line connected to the RG a registration request to register an AUN3 device behind the RG, and transmitting to the core network a message comprising the received registration request to register the AUN3 device behind the RG and an indication indicating whether there is an existing N2 connection to the core network for the RG connected to the line on which the registration request is received.

### RELATED APPLICATIONS

This application claims the benefit of provisional patent application Ser. No. 63/464,991, filed May 9, 2023, the disclosure of which is hereby incorporated herein by reference in its entirety.

### TECHNICAL FIELD

The present disclosure relates to a method for handling registration, deregistration and service requests for Authenticable Non-3GPP devices behind a Fifth Generation Residential Gateway (5G-RG).

### BACKGROUND

As part of Third Generation Partnership Program (3GPP) Service and Systems Aspects Working Group (SA2), it has been agreed to support User Equipment devices (UEs) and devices connecting behind a Fifth Generation Residential Gateway (5G-RG). One solution is to connect Authenticable Non-3GPP (AUN3) devices towards a 5G Core (5GC). These are devices that can authenticate towards 5GC, but they do not support Non-Access Stratum (NAS) messages via non-3GPP access. To support such AUN3 devices, a 5G-RG can be used to connect AUN3 devices to the 5GC based on the following architecture in FIG. 1.

In FIG. 1, an AUN3 device 102 is behind a 5G-RG 104 that is connected to core network (e.g., the Access and Mobility Function (AMF) 108) via 3GPP access 106 (e.g., a Radio Access Network), and/or via a Wireline Access Gateway Function (W-AGF) 110.

Here the AUN3 device 102 has its own subscription in 5GC, but as mentioned above, it does not support Non-Access Stratum (NAS) over non-3GPP access. Therefore, the 5G-RG 104 which supports NAS towards 5GC issues a NAS register and handles Remote Management (RM) and Connection Management (CM) related signaling on behalf of the AUN3 device 102 (N1 interface in the figure above). The 5G-RG 104 is connected to the 5GC via W-AGF 110. The AMF 108 handles the user registration.

The 5G-RG 104 will also issue a NAS register and handle RM and CM related for itself, i.e., to register itself to 5GC and establish Protocol Data Unit (PDU) Sessions. The 5G-RG will thus manage multiple NAS instances (one for itself, and one per AUN3 device)

In this setup the following requirement should be met:
AUN3 devices 102 should only get services from 5GC via an 5G-RG 104 if the 5G-RG 104 is registered and connected to the 5GC.

The solution that already been discussed in Change Request S2-2304468 proposes to transmit Globally Unique Temporary ID (GUTI) of the 5G-RG 104 in the registration request of every AUN3 devices 102 and 5GC makes sure that the AUN3 devices 102 are only registered while the 5G-RG 104 is registered. This can be done by selecting the same AMF 108 for the 5G-RG 104 and for all AUN3 devices 102 of the 5G-RG 104. The AMF 108 will receive a NAS Registration Request for an AUN3 device 102, and also receive the 5G-RG GUTI together with the NAS Registration Request. The AMF 108 can then check if the received 5G-RG GUTI corresponds to an active registration in the AMF 108. If it does, the AMF 108 can accept the registration request for the AUN3 device 102. Otherwise, the AMF 108 rejects the registration request of the AUN3 device 102.

The problem with the solution in Change Request S2-2304468 is that it has a high impact on 5GC. Specifically, the solution requires that a UE context of the 5G-RG and the AUN3 devices in 5GC become connected to each other, so that e.g., if the 5G-RG 104 deregisters, the AMF 108 deregisters all of the connected AUN3 devices as well. Furthermore, the solution relies on the assumption that the 5G-RG 104 provides right information on whether it is registering itself or an AUNT3 device, which is not necessarily true. The 5G-RG 104 is a UE and cannot therefore be considered as a trusted network entity.

### SUMMARY

Various embodiments disclosed herein provide for a method performed by a Wireline Access Gateway Function (W-AGF) for handling registration and connection to a core network of one or more Authenticable Non-Third Generation Partnership Program (3GPP) (AUN3) devices behind a residential gateway (RG) connected with a line to the W-AGF. The method includes receiving from the line connected to the RG a registration request to register an AUN3 device behind the RG, and transmitting to the core network a message comprising the received registration request to register the AUN3 device behind the RG and an indication indicating whether there is an existing N2 connection to the core network for the RG connected to the line on which the registration request is received.

In an embodiment, the method further includes receiving from the core network a request to release a context associated with the RG, identifying one or more AUN3 devices behind the RG that are connected to the core network, and for each of the one or more AUN3 devices, sending to the core network a release message to release a context associated with the corresponding AUN3 device and wherein the release message includes an indication that the release message is due to disconnection of the RG.

In an embodiment, the method further includes determining that there is an existing N2 connection to the core network for the RG connected to the line on which the registration request is received is based on determining that a Level Wireline Access Characteristic (LWAC) parameter associated with the registration request exists in the subscription data.

In an embodiment, the method further includes determining that there is an existing N2 connection to the core network for the RG connected to the line on which the registration request is received based on an indication of a device type in the registration request indicating whether the device is the RG or the AUN3 device.

In an embodiment, the transmitting to the core network comprises transmitting the registration request to an Access and Mobility Function (AMF) in the core network.

In an embodiment, the transmitting comprises transmitting the registration request with an N2 parameter indicating there is a registered and connected RG.

In an embodiment, the method further includes receiving a service request associated with an AUN3 device, determining whether a registered and connected RG is associated with a connection on which the service request is received, and performing a network operation based on a result of the determining.

In an embodiment, in response to determining there is a connected RG associated with the service request, the performing the network operation comprises forwarding the service request to the AMF with an indication that there is a registered and connected RG associated with the service request.

In an embodiment, in response to determining there is no connected RG associated with the service request, the performing the network operation comprises rejecting the service request associated with the AUN3 device.

In an embodiment, A W-AGF is provided that includes processing circuitry configured to cause the W-AGF to perform the embodiments described above.

In an embodiment, a method is provided that is performed by an Access and Mobility Function (AMF) that includes receiving, from the W-AGF, a message comprising a registration request to register an AUN3 device behind the RG and an indication indicating whether there is an existing N2 connection to the core network for the RG connected to the line on which the registration request is received at the W-AGF, and in response to determining based on the indication that there is no existing N2 connection for the RG connected to the line on which the registration request is received at the W-AGF, rejecting the registration request of the AUN3 device.

In an embodiment, the method further includes receiving for each registered one or more AUN3 devices behind the RG a release message to release a context associated with the corresponding AUN3 device and wherein the release message includes an indication that the release message is due to disconnection of the RG and initiating deregistration of each of the registered one or more AUN3 devices.

In an embodiment, an AMF is provided that includes processing circuitry configured to cause the AMF to perform the embodiments described above.

### BRIEF DESCRIPTION OF THE DRAWINGS

The accompanying drawing figures incorporated in and forming a part of this specification illustrate several aspects of the disclosure, and together with the description serve to explain the principles of the disclosure.

FIG. 1 illustrates a sample Fifth Generation Residential Gateway (5G-RG) connected to a core network and an Authenticable Non-Third Generation Partnership Program (3GPP) device;

FIGS. 2A and 2B illustrate an exemplary message sequence chart for registering an Authenticable Non-3GPP device behind the 5G-RG according to an embodiment of the present disclosure;

FIG. 3 illustrates an exemplary message sequence chart for deregistering an Authenticable Non-3GPP device behind the 5G-RG according to an embodiment of the present disclosure;

FIG. 4 illustrates an exemplary message sequence chart for providing a service request for an Authenticable Non-3GPP device behind the 5G-RG according to an embodiment of the present disclosure;

FIGS. 5A, 5B, and 5C illustrate an exemplary message sequence chart for registering an Authenticable Non-3GPP device behind the 5G-RG according to a different embodiment of the present disclosure;

FIG. 6 illustrates an exemplary message sequence chart for deregistering an Authenticable Non-3GPP device behind the 5G-RG according to a different embodiment of the present disclosure;

FIG. 7 illustrates one example of a cellular communications system in which embodiments of the present disclosure may be implemented;

FIG. 8 illustrates a wireless communication system represented as a 5G network architecture composed of core Network Functions (NFs);

FIG. 9 illustrates a 5G network architecture using service-based interfaces between the NFs in the Control Plane (CP);

FIG. 10 is a schematic block diagram of a network node according to some embodiments of the present disclosure;

FIG. 11 is a schematic block diagram that illustrates a virtualized embodiment of the network node according to some embodiments of the present disclosure; and

FIG. 12 is a schematic block diagram of the network node according to some other embodiments of the present disclosure.

### DETAILED DESCRIPTION

Some of the embodiments contemplated herein will now be described more fully with reference to the accompanying drawings. Other embodiments, however, are contained within the scope of the subject matter disclosed herein, the disclosed subject matter should not be construed as limited to only the embodiments set forth herein; rather, these embodiments are provided by way of example to convey the scope of the subject matter to those skilled in the art.

Core Network Node: As used herein, a “core network node” is any type of node in a core network or any node that implements a core network function. Some examples of a core network node include, e.g., a Mobility Management Entity (MME), a Packet Data Network Gateway (P-GW), a Service Capability Exposure Function (SCEF), a Home Subscriber Server (HSS), or the like. Some other examples of a core network node include a node implementing an Access and Mobility Management Function (AMF), a User Plane Function (UPF), a Session Management Function (SMF), an Authentication Server Function (AUSF), a Network Slice Selection Function (NSSF), a Network Exposure Function (NEF), a Network Function (NF) Repository Function (NRF), a Policy Control Function (PCF), a Unified Data Management (UDM), or the like.

Note that the description given herein focuses on a 3GPP cellular communications system and, as such, 3GPP terminology or terminology similar to 3GPP terminology is oftentimes used. However, the concepts disclosed herein are not limited to a 3GPP system.

Note that, in the description herein, reference may be made to the term “cell”; however, particularly with respect to 5G NR concepts, beams may be used instead of cells and, as such, it is important to note that the concepts described herein are equally applicable to both cells and beams.

There currently exist certain challenge(s). The problem with the proposal in Change Request S2-2304468 is that it has a high impact on 5GC. Specifically, the solution requires that UE context of the Fifth Generation Residential Gateway (5G-RG) and the Authenticable Non-Third Generation Partnership Project (AUN3) devices in 5GC become connected to each other, so that e.g., if the 5G-RG deregisters, the AMF deregisters all of the connected AUN3 devices as well. Furthermore, the solution relies on the assumption that the 5G-RG provides the right information on whether it is registering itself or an AUN3 device, which is not necessarily true. The 5G-RG is a UE and cannot therefore be considered as a trusted network entity.

Certain aspects of the present disclosure and their embodiments may provide solutions to the aforementioned or other challenges.

The proposed method to handle the connection of the AUN3 devices in relation to the 5G-RG registration mode relies on the wireline Access Gateway Function (W-AGF) to keep track of the registered 5G-RGs and the AUN3 devices that are connected to each 5G-RG. There are 4 proposed solutions.
Option 1: W-AGF keeps track of the relation between RG and W-AGF devices. With every Uplink Non-Access Stratum (UL NAS) message, W-AGF indicates to AMF whether there is an existing N2 connection for a Residential Gateway (RG) already, or not. AMF rejects the UL NAS message if it is from AUN3 device and W-AGF did not indicate that there is an existing N2 connection for an RG. W-AGF and AMF identifies whether a device connecting is RG or not based on subscription data (e.g., existence of RG Level Wireline Access Characteristics (RG-LWAC) parameter in subscription data).
Option 2: W-AGF keeps track of the relation between RG and W-AGF devices. If a new N2 connection is created for a non-RG device, and there is no existing N2 connection for an RG, W-AGF immediately releases the N2 connection for the non-RG device. In this option, there are no impacts to AMF. W-AGF and AMF jointly identify whether a device connecting is RG or not based on subscription data (e.g., existence of RG-LWAC parameter in subscription data). A new cause for Access Network (AN) release can be added for this case.
Options 3 and 4: (these option trusts the message provided by 5G-RG): These options are the same as option 1 and 2 respectively, but instead of identifying the device type (RG vs AUN3) based on subscription data, the 5G-RG indicates the device type to W-AGF in the message sent to W-AGF.

The present disclosure provides a new method to handle the “conditional” registration and deregistration of AUN3 devices connected 5GC via 5G-RG.

This present disclosure involves transmitting a new parameter via the N2 connection between the W-AGF and AMF

This present disclosure involves a new Method and signaling steps to handle the registration, deregistration, and service request for AUN3 devices behind 5G-RG.

A new 5G Mobility Management cause for the case that the AMF rejects the Registration Request for the AUN3 device if the connected 5G-RG is not registered.

A new reject cause from W-AGF to 5R-RG if the W-AGF identifies the Registration Request for the AUN3 device should be rejected due to the 5R-RG is not registered.

There are, proposed herein, various embodiments which address one or more of the issues disclosed herein.

In an embodiment a method can performed by a W-AGF for handling registration of AUN3 devices with a core network. The method can include receiving a registration request from a device comprising at least one of a 5G-RG or an AUN3 device. The method can also include determining whether a registered and connected 5G-RG is associated with a connection on which the registration request is received. The method can also include performing a network operation based on a result of the determining.

In an embodiment, W-AGF can be provided that is configured for handling registration of AUN3 devices with a core network, the W-AGF comprising processing circuitry configured to: receive a registration request from a device comprising at least one of a 5G-RG or an AUN3 device, determine whether a registered and connected 5G-RG is associated with a connection on which the registration request is received, and perform a network operation based on a result of the determining.

In another embodiment, a method can be performed by an AMF of a core network for handling registration of AUN3 devices. The method can include receiving from a W-AGF a registration request from a device comprising at least one of a 5G-RG or an AUN3 device. The method can include in response to the registration request comprising an indication that there is a registered gateway already connected, accepting the registration request. The method can include in response to the registration request not comprising an indication that there is a registered and connected gateway already connected, rejecting the registration request in response to the registration request not corresponding to a 5G-RG.

In another embodiment, an AMF can be provided that is configured for handling registration of AUN3 devices. The AMF can include processing circuitry that can receive from a W-AGF a registration request from a device comprising at least one of a 5G-RG or an AUN3 device. The processing circuitry can also, in response to the registration request comprising an indication that there is a registered gateway already connected, accepting the registration request. The processing circuitry can also, in response to the registration request not comprising an indication that there is a registered and connected gateway already connected, rejecting the registration request in response to the registration request not corresponding to a 5G-RG.

Certain embodiments may provide one or more of the following technical advantage(s). The proposed solution enables provisioning of services to AUN3 devices behind 5G-RG only if the 5G-RG is registered in 5GC, with minimal impact to the 5GC. In one option of this solution only AMF is affected to check the existence of LWAC, and W-AGF to keep track of the registered 5G-RG's and the AUN3 devices connected to them. In the other option, the AMF is not impacted and only W-AGF is impacted to keep track of the AUN3 devices behind an RG and release the N2 connection as needed. Furthermore, this solution relies on subscription information (e.g., 5G-LWAC parameter) to distinguish the 5G-RGs from other users instead of relying on 5G-RG to do that. An alternative option is that the RG itself indicates to W-AGF whether the NAS message is for the RG itself, or for a AUN3 device.

It is to be appreciated that in the present disclosure, LWAC is used as an identifier in the subscription data to identify whether a registration/device is for 5G-RG or AUN3, however it can be any generic identifier in the subscription data.

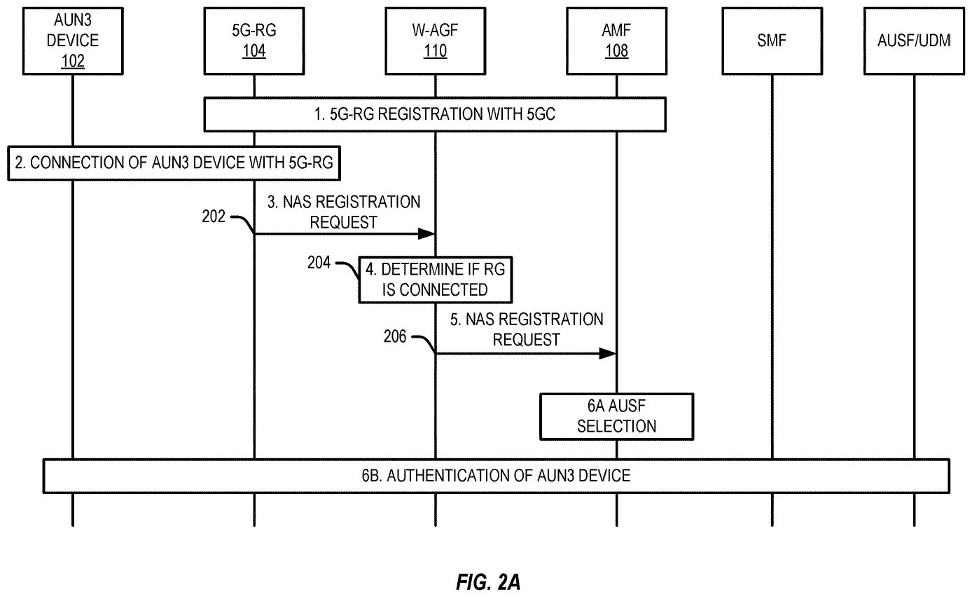

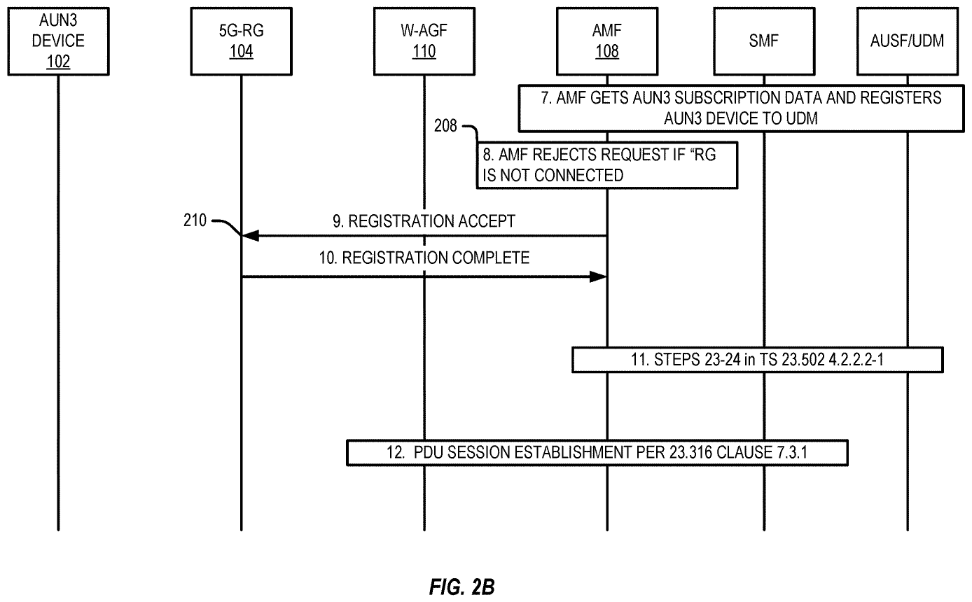

FIGS. 2A and 2B illustrate an exemplary message sequence chart for registering an Authenticable Non-3GPP device behind the 5G-RG according to an embodiment of the present disclosure. It is to be appreciated that FIGS. 2A, 2B, and the other message sequence charts are adapted from message sequence charts in 3GPP TR 23.700-17 v18.0.0, but with modifications representing the embodiments disclosed herein. When reference is made to steps being performed according to standard procedures, reference is being made to the message sequence charts and steps from 3GPP TR 23.700-17v18.0.0.

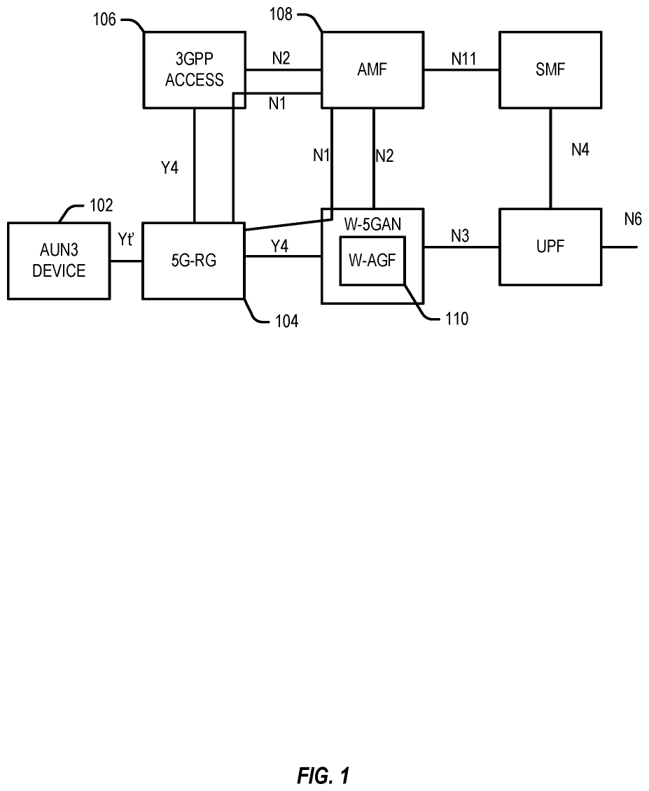

The solution uses the architecture shown in FIG. 1. Three new system procedures are defined to handle the connectivity of AUN3 devices behind 5G-RG to 5GC, namely, registration of 5G-RG/AUN3 devices, deregistration of 5G-RG, and service request for AUN3 devices. A high-level description of the novel aspects of the solution is described as follows.
1. When W-AGF 110 receives a registration request or a service request from a line that is connected to a 5G-RG 104 it transmits an additional N2 parameter to AMF 108 which indicates if there are any 5G-RG 104 connected to the line (or with the same Medium Access Control (MAC) address) or not.
2. In case of the service request, if the indicator described above shows that there are no registered 5G-RG 104, then AMF 108 rejects the request, unless the service request is related to the 5G-RG 104 itself (e.g., the UE subscription data contains RG-LWAC).
3. In the case of registration request, the AMF 108 only accepts the registration request if either there exists a registered 5G-RG 104 connected to the line (indicated in the N2 message) or the device is a 5GRG 104 itself (it has LWAC parameter in its subscription data).
4. W-AGF 110 keeps track of the 5G-RG 104 connected to each line and all of the AUN3 102 devices connected to it. It can identify whether a device is a 5G-RG or not by checking if the LWAC parameter is sent from the AMF 108 to the W-AGF 110 when setting up the N2 connection.
5. If the 5G-RG 104 deregisters, then W-AGF 110 performs the Access Network (AN) Release for all the registered AUN3 devices 102 connected to the 5GRG 104.
6. Besides this, if the 5G-RG 104 initiates deregistration, it should first deregister all the AUN3 devices connected to it before it deregisters itself.

Call flows for registration, deregistration, and service requests, are shown in FIGS. 2A and 2B.

Steps 1-3 are based on existing specifications. As an example, in step 3 at 202, the 5G-RG 104 provides a NAS Registration request to the W-AGF 110 that includes AN parameters and a MAC address of the 5G-RG 104.

Step 4 at 204: W-AGF 110 determines if the 5G-RG 104 is registered in the same line or not. It can do this by checking if the LWAC parameter has been received from AMF for a registered device that is connected the same line. If this is the first NAS PDU for a device (either AUN3 device 102 or 5G-RG 104), the W-AGF 110 does not know if it is an RG or an AUN3 device, unless the RG indicates it itself. Instead, in an embodiment, the W-AGF 110 can learn this when N2 setup is complete based on subscription data received from the AMF 108.

Alt-a: If W-AGF 110 identifies the Registration Request for the AUN3 device 102 should be rejected due to that there is no N2 connection for a 5R-RG 104, the W-AGF 110 rejects the message from 5R-RG 104 with a new cause code, steps 5-9 (e.g., 206, 208, and 210) are skipped.

Alt-b: If W-AGF 110 identifies the Registration Request for the AUN3 device 102 and there is no N2 connection for any 5R-RG 104, W-AGF 110 forwards the message to the AMF 108.

Step 5 206: If there exists a 5G-RG 104 connected to the line or for the MAC address (that the registration request is sent), W-AGF 110 includes a new parameter to the N2 message for registration request and sends the N2 message, that indicates that the 5G-RG 104 is already connected, to the AMF 108. It is to be appreciated that in an embodiment, the W-AGF 110 can include this indication with every UL NAS PDU.

Steps 6-7 are based on existing specifications.

Step 8 208: The AMF 108 rejects the registration request with a new 5GMM cause if W-AGF 110 did not indicate that an existing 5G-RG 104 is connected (step 5) and the device is not 5G-RG 104 itself (the subscription data does not contain RG-LWAC) (novel). Otherwise, it accepts the request at 210.

Steps 9-12 are based on existing specifications.

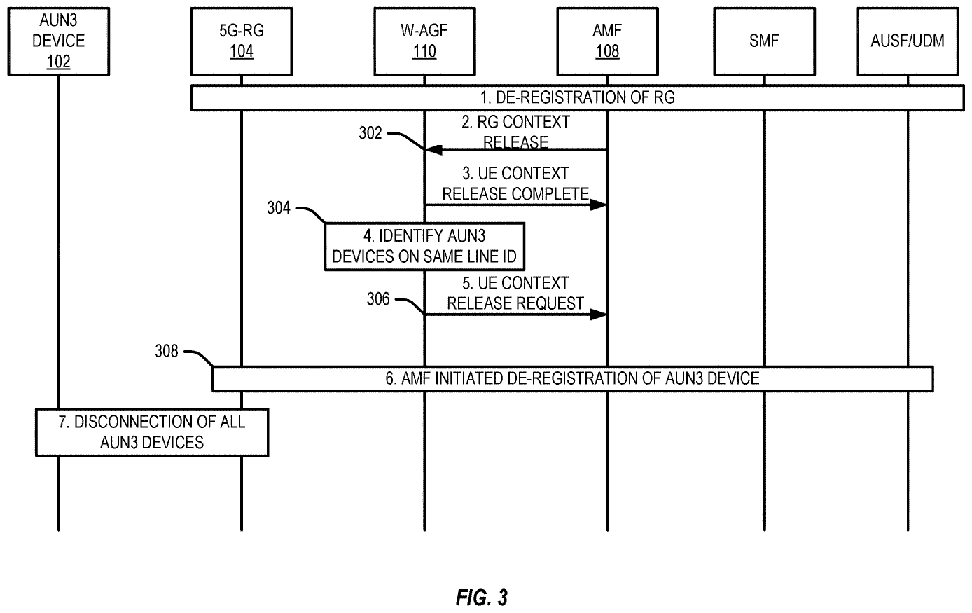

FIG. 3 illustrates an exemplary message sequence chart for deregistering an AUN3 device 102 behind the 5G-RG 104 according to an embodiment of the present disclosure.

Step 1: If 5G-RG 104 initiates deregistration, it should first deregister all the AUN3 devices 102 connected to it before it deregisters itself. The rest of the call flow assumes that the core network initiates the deregistration of the 5G-RG 104, or the RG did not deregister the AUN3 devices 102 before initiating deregistration.

Steps 1-3 are based on existing specifications. At step 2 302, the W-AGF 110 receives a Context Release Command from the AMF 108.

Step 4 304 is the same as Step 4 204 of FIG. 2A, and in addition to W-AGF 110 determining if the 5G-RG 104 is registered in the same line or not by checking if the LWAC parameter has been received from AMF 108 for a registered device that is connected the same line, the W-AGF 110 can also identify AUN3 devices on the same Line.

Step 5-7: For each of the AUN3 devices 102 behind the 5G-RG 104 that are connected to the core network, W-AGF 110 requests context release from AMF 108 at 306. The W-AGF 110 can include an indication that this is because the 5G-RG 104 has been disconnected. The AMF 108 may use this indication as a trigger to deregister the UE at step 308.

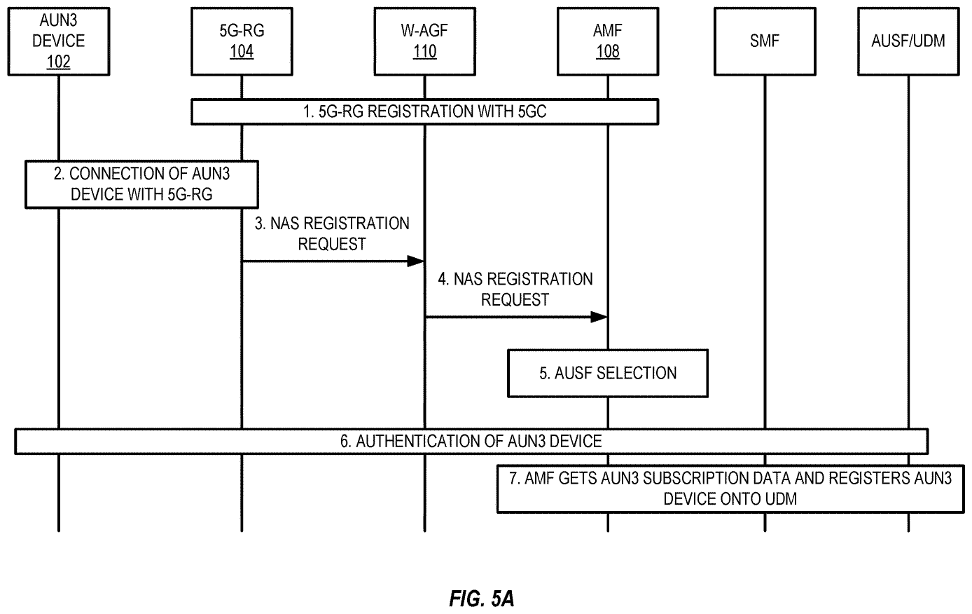

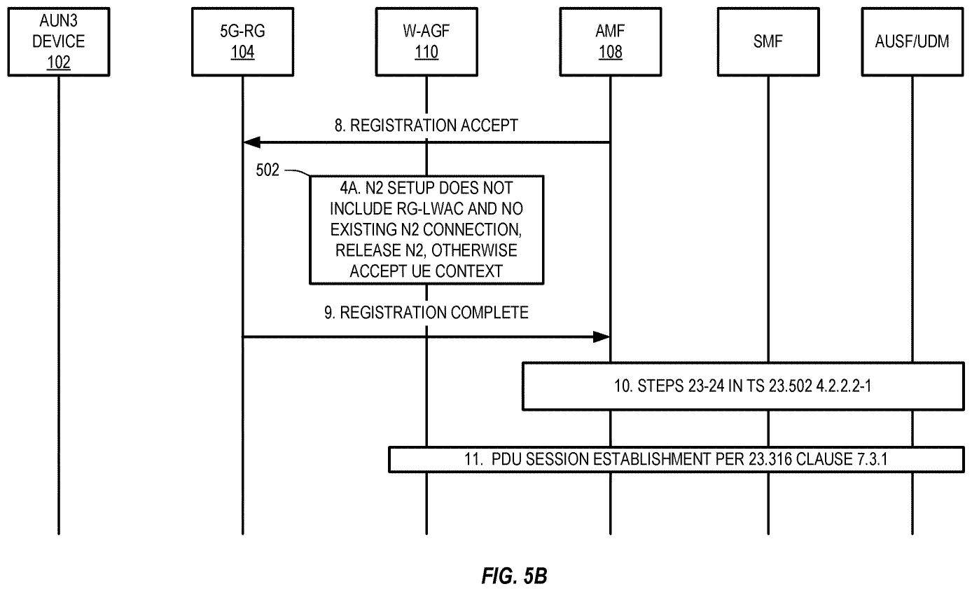

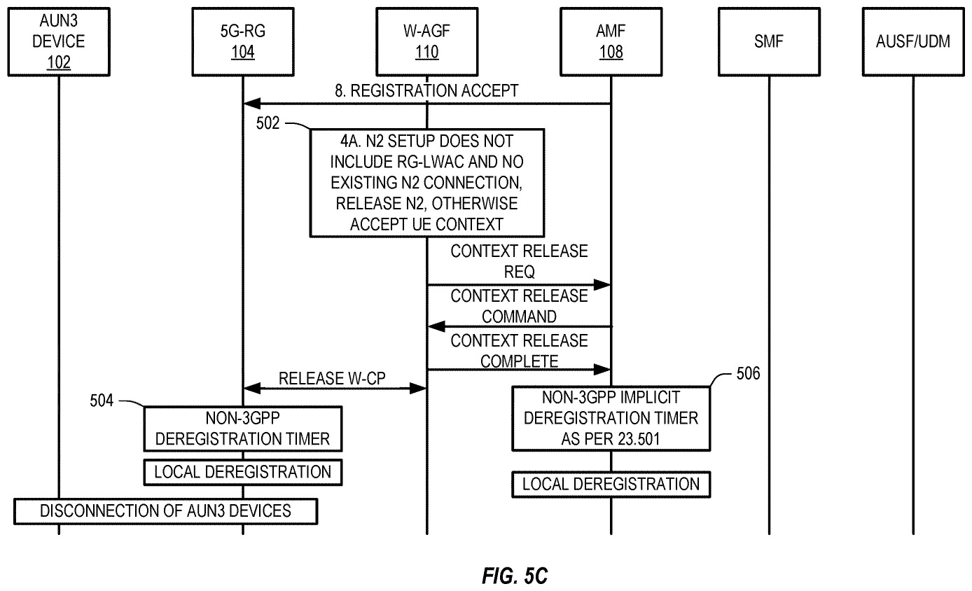

Alternatively, the W-AGF 110 can release the AUN3 devices' N2 connections 306 (step 5) without providing a new indication: this case is shown in a call flow in FIG. 5B at step 502 further below.

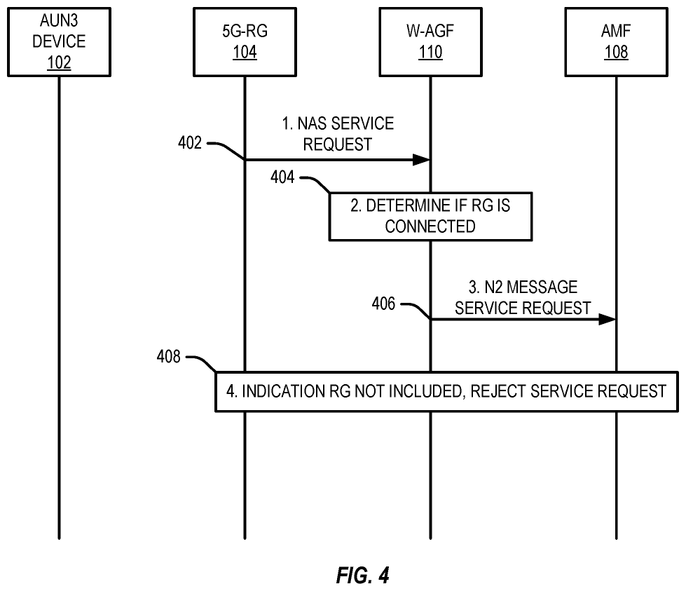

FIG. 4 illustrates an exemplary message sequence chart for providing a service request for an Authenticable Non-3GPP device behind the 5G-RG according to an embodiment of the present disclosure Step 1 402 is based on existing specifications where the W-AGF 110 receives a service request from 5G-RG 104.

Step 2 404 is similar as Step 4 204 of FIG. 2A where W-AGF 110 can determine if the 5G-RG 104 is connected in the same line or not by checking if the LWAC parameter has been received from AMF 108 for a registered device that is connected the same line.

Step 3 406: If there exists a 5G-RG 104 connected to the line (that the registration request is sent), W-AGF 110 includes a new parameter to the N2 message for the service request when sending the N2 message of the service request to the AMF 108.

Step 4 408: If there is no 5G-RG 104 connected to the line (the indicator does not exist), then the AMF 108 rejects the service request with a new 5G Mobility Management (5GMM) cause code.

FIGS. 5A, 5B, and 5C illustrate an exemplary message sequence chart for registering an Authenticable Non-3GPP device behind the 5G-RG according to a different embodiment (e.g., Option 2) of the present disclosure.

FIG. 5A displays steps 1-7 of the standard steps for 5G-RG registration, and in FIG. 5B, at step 4a 502, the W-AGF 110 can determine if the N2 setup does not contain the RG-LWAC, and if there is no other existing N2 connection on the same line (or RG MAC address) that has the RG-LWAC, then the W-AGF 110 can release the N2 or otherwise reject the registration. If either the N2 setup does include the RG-LWAC or there is an existing N2 connection on the same line, then the W-AGF 110 can accept the UE context.

This is also illustrated in FIG. 5C which is another version of the message sequence chart, where after the W-AGF 110 releases the N2, the 5G-RG 104 can start the UE Non-3GPP Deregistration timer at 504 as per existing TS 23.501, or the AMF 108 can start the Network Non-3GPP Implicit Deregistration timer at 506 as per existing TS 23.501.

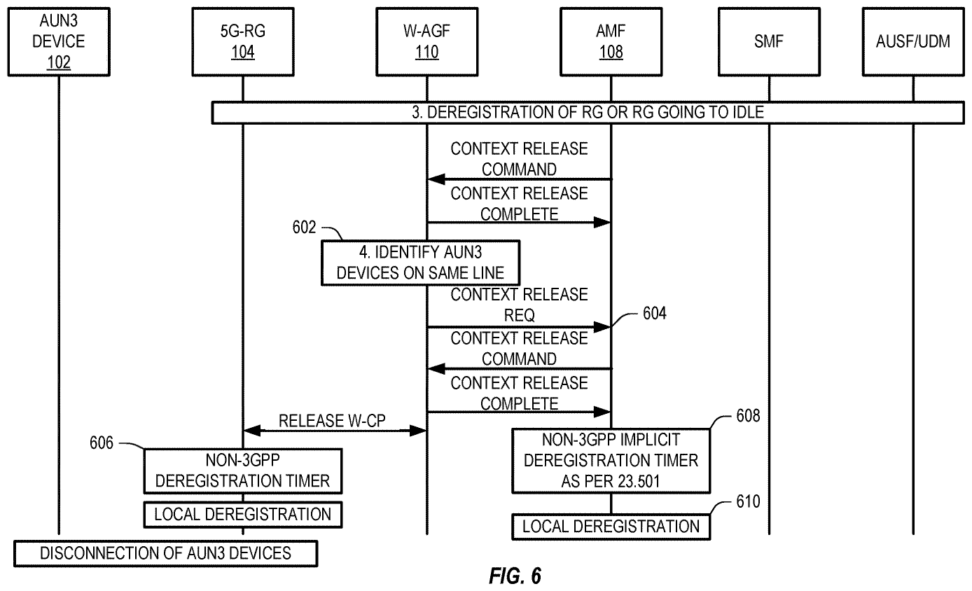

FIG. 6 illustrates an exemplary message sequence chart for deregistering an Authenticable Non-3GPP device behind the 5G-RG according to an Option 2 of the present disclosure.

The solution reuses the existing procedures such as step 4 602 where the W-AGF determines if the 5G-RG 104 is registered in the same line or not by checking if the LWAC parameter has been received from AMF 108 for a registered device that is connected the same line, the W-AGF 110 can also identify AUN3 devices on the same Line. The W-AGF 110 can then trigger the release of the 5G-RG at 604 by sending a UE Context Release Request to the AMF 108. After W-AGF 110 releases the N2, the 5G-RG 104 can start the UE Non-3GPP Deregistration timer at 606 that follows existing TS 23.501, or the AMF 108 can start the Network Non-3GPP Implicit Deregistration timer at 608 that follows existing TS 23.501 and the perform deregistration at step 610.

OPTION 3: The solution is similar to Option1, except the device type is indicated by the 5G-RG 104 to W-AGF 110. In this case the W-AGF 110 does not need to rely on parameters (e.g., RG-LWAC) received from AMF 108 to determine whether a device is 5G-RG 104 or AUN3 102.

OPTION 4: The solution is similar to Option2, except the device type is indicated by the 5G-RG 104 to W-AGF 110. In this case the W-AGF 110 does not need to rely on parameters (e.g., RG-LWAC) received from AMF 108 to determine whether a device is 5G-RG 104 or AUN3 102.

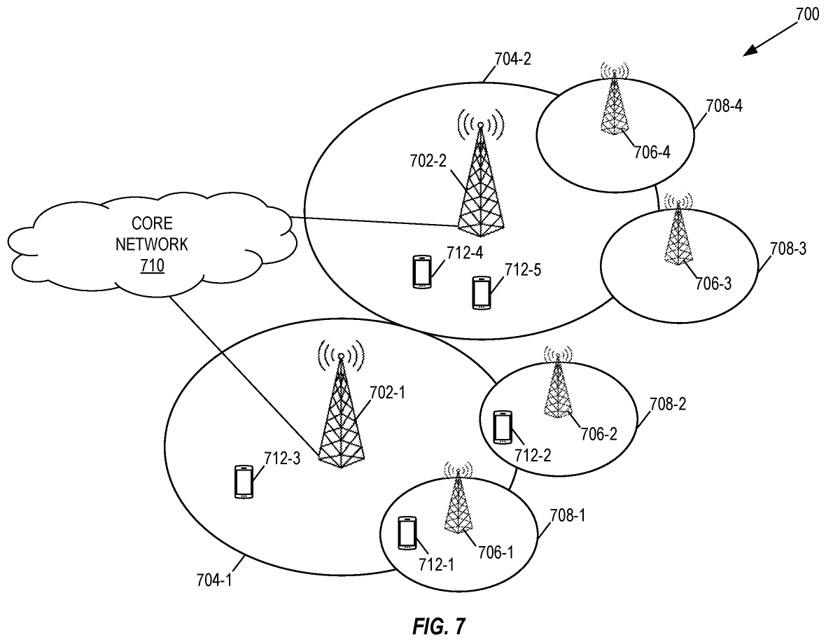

FIG. 7 illustrates one example of a cellular communications system 700 in which embodiments of the present disclosure may be implemented. In the embodiments described herein, the cellular communications system 700 is a 5G system (5GS) including a Next Generation RAN (NG-RAN) and a 5G Core (5GC). In this example, the RAN includes base stations 702-1 and 702-2, which in the 5GS include NR base stations (gNBs), controlling corresponding (macro) cells 704-1 and 704-2. The base stations 702-1 and 702-2 are generally referred to herein collectively as base stations 702 and individually as base station 702. Likewise, the (macro) cells 704-1 and 704-2 are generally referred to herein collectively as (macro) cells 704 and individually as (macro) cell 704. The RAN may also include a number of low power nodes 706-1 through 706-4 controlling corresponding small cells 708-1 through 708-4. The low power nodes 706-1 through 706-4 can be small base stations (such as pico or femto base stations) or RRHs, or the like. Notably, while not illustrated, one or more of the small cells 708-1 through 708-4 may alternatively be provided by the base stations 702. The low power nodes 706-1 through 706-4 are generally referred to herein collectively as low power nodes 706 and individually as low power node 706. Likewise, the small cells 708-1 through 708-4 are generally referred to herein collectively as small cells 708 and individually as small cell 708. The cellular communications system 700 also includes a core network 710, which in the 5G System (5GS) is referred to as the 5GC. The base stations 702 (and optionally the low power nodes 706) are connected to the core network 710.

The base stations 702 and the low power nodes 706 provide service to wireless communication devices 712-1 through 712-5 in the corresponding cells 704 and 708. The wireless communication devices 712-1 through 712-5 are generally referred to herein collectively as wireless communication devices 712 and individually as wireless communication device 712. In the following description, the wireless communication devices 712 are oftentimes UEs, but the present disclosure is not limited thereto.

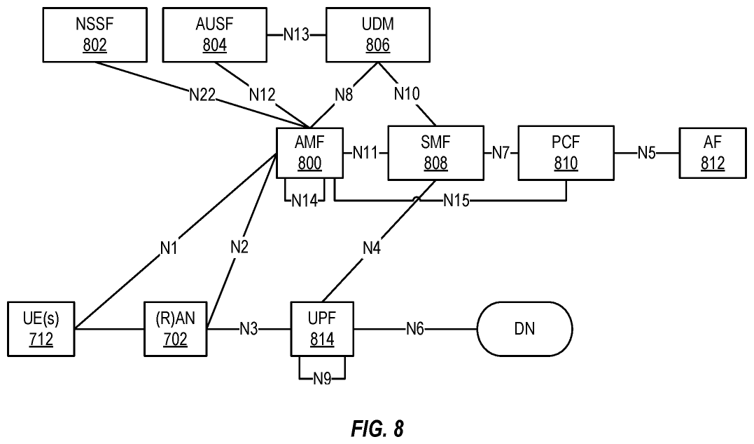

FIG. 8 illustrates a wireless communication system represented as a 5G network architecture composed of core Network Functions (NFs), where interaction between any two NFs is represented by a point-to-point reference point/interface. FIG. 8 can be viewed as one particular implementation of the system 700 of FIG. 7.

Seen from the access side the 5G network architecture shown in FIG. 8 comprises a plurality of UEs 712 connected to either a RAN 702 or an Access Network (AN) as well as an AMF 800. Typically, the R(AN) 702 comprises base stations, e.g., such as eNBs or gNBs or similar. Seen from the core network side, the 5GC NFs shown in FIG. 8 include a NSSF 802, an AUSF 804, a UDM 806, the AMF 800, a SMF 808, a PCF 810, and an Application Function (AF) 812.

Reference point representations of the 5G network architecture are used to develop detailed call flows in the normative standardization. The N1 reference point is defined to carry signaling between the UE 712 and AMF 800. The reference points for connecting between the AN 702 and AMF 800 and between the AN 702 and UPF 814 are defined as N2 and N3, respectively. There is a reference point, N11, between the AMF 800 and SMF 808, which implies that the SMF 808 is at least partly controlled by the AMF 800. N4 is used by the SMF 808 and UPF 814 so that the UPF 814 can be set using the control signal generated by the SMF 808, and the UPF 814 can report its state to the SMF 808. N9 is the reference point for the connection between different UPFs 814, and N14 is the reference point connecting between different AMFs 800, respectively. N15 and N7 are defined since the PCF 810 applies policy to the AMF 800 and SMF 808, respectively. N12 is required for the AMF 800 to perform authentication of the UE 712. N8 and N10 are defined because the subscription data of the UE 712 is required for the AMF 800 and SMF 808.

The 5GC network aims at separating UP and CP. The UP carries user traffic while the CP carries signaling in the network. In FIG. 8, the UPF 814 is in the UP and all other NFs, i.e., the AMF 800, SMF 808, PCF 810, AF 812, NSSF 802, AUSF 804, and UDM 806, are in the CP. Separating the UP and CP guarantees each plane resource to be scaled independently. It also allows UPFs to be deployed separately from CP functions in a distributed fashion. In this architecture, UPFs may be deployed very close to UEs to shorten the Round Trip Time (RTT) between UEs and data network for some applications requiring low latency.

The core 5G network architecture is composed of modularized functions. For example, the AMF 800 and SMF 808 are independent functions in the CP. Separated AMF 800 and SMF 808 allow independent evolution and scaling. Other CP functions like the PCF 810 and AUSF 804 can be separated as shown in FIG. 8. Modularized function design enables the 5GC network to support various services flexibly.

Each NF interacts with another NF directly. It is possible to use intermediate functions to route messages from one NF to another NF. In the CP, a set of interactions between two NFs is defined as service so that its reuse is possible. This service enables support for modularity. The UP supports interactions such as forwarding operations between different UPFs.

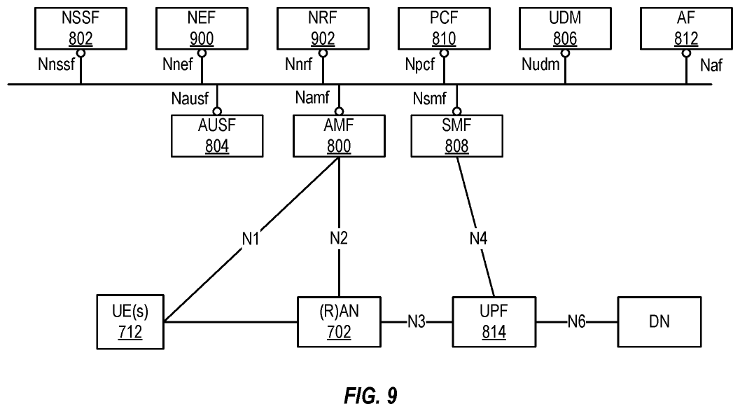

FIG. 9 illustrates a 5G network architecture using service-based interfaces between the NFs in the CP, instead of the point-to-point reference points/interfaces used in the 5G network architecture of FIG. 8. However, the NFs described above with reference to FIG. 8 correspond to the NFs shown in FIG. 9. The service(s) etc. that a NF provides to other authorized NFs can be exposed to the authorized NFs through the service-based interface. In FIG. 9 the service based interfaces are indicated by the letter “N” followed by the name of the NF, e.g., Namf for the service based interface of the AMF 800 and Nsmf for the service based interface of the SMF 808, etc. The NEF 900 and the NRF 902 in FIG. 9 are not shown in FIG. 8 discussed above. However, it should be clarified that all NFs depicted in FIG. 8 can interact with the NEF 900 and the NRF 902 of FIG. 9 as necessary, though not explicitly indicated in FIG. 8.

Some properties of the NFs shown in FIGS. 8 and 9 may be described in the following manner. The AMF 800 provides UE-based authentication, authorization, mobility management, etc. A UE 712 even using multiple access technologies is basically connected to a single AMF 800 because the AMF 800 is independent of the access technologies. The SMF 808 is responsible for session management and allocates Internet Protocol (IP) addresses to UEs. It also selects and controls the UPF 814 for data transfer. If a UE 712 has multiple sessions, different SMFs 808 may be allocated to each session to manage them individually and possibly provide different functionalities per session. The AF 812 provides information on the packet flow to the PCF 810 responsible for policy control in order to support QoS. Based on the information, the PCF 810 determines policies about mobility and session management to make the AMF 800 and SMF 808 operate properly. The AUSF 804 supports authentication function for UEs or similar and thus stores data for authentication of UEs or similar while the UDM 806 stores subscription data of the UE 712. The Data Network (DN), not part of the 5GC network, provides Internet access or operator services and similar.

An NF may be implemented either as a network element on a dedicated hardware, as a software instance running on a dedicated hardware, or as a virtualized function instantiated on an appropriate platform, e.g., a cloud infrastructure.

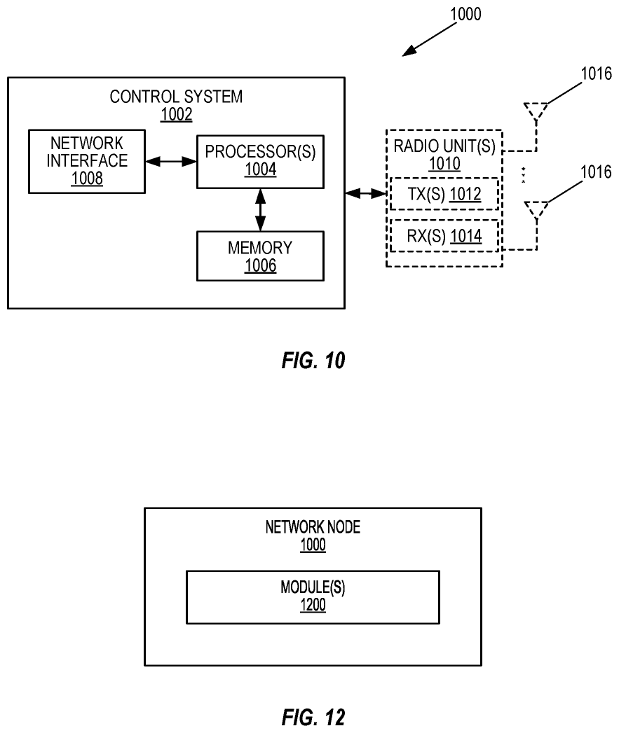

FIG. 10 is a schematic block diagram of a network node 1000 (e.g., such as W-AGF 110 or AMF 108 as described here) according to some embodiments of the present disclosure. Optional features are represented by dashed boxes. The network node 1000 may be, for example, a base station 702 or 706 or a network node that implements all or part of the functionality of the base station 702 or gNB described herein. As illustrated, the network node 1000 includes a control system 1002 that includes one or more processors 1004 (e.g., Central Processing Units (CPUs), Application Specific Integrated Circuits (ASICs), Field Programmable Gate Arrays (FPGAs), and/or the like), memory 1006, and a network interface 1008. The one or more processors 1004 are also referred to herein as processing circuitry. In addition, if the network node 1000 is a radio access node (e.g., a base station 702, gNB, or network node that implements at least some of the functionality of the base station 702 or gNB), the network node 1000 may include one or more radio units 1010 that each includes one or more transmitters 1012 and one or more receivers 1014 coupled to one or more antennas 1016. The radio units 1010 may be referred to or be part of radio interface circuitry. In some embodiments, the radio unit(s) 1010 is external to the control system 1002 and connected to the control system 1002 via, e.g., a wired connection (e.g., an optical cable). However, in some other embodiments, the radio unit(s) 1010 and potentially the antenna(s) 1016 are integrated together with the control system 1002. The one or more processors 1004 operate to provide one or more functions of the network node 1000 as described herein (e.g., one or more functions of a base station 702 or gNB described herein). In some embodiments, the function(s) are implemented in software that is stored, e.g., in the memory 1006 and executed by the one or more processors 1004.

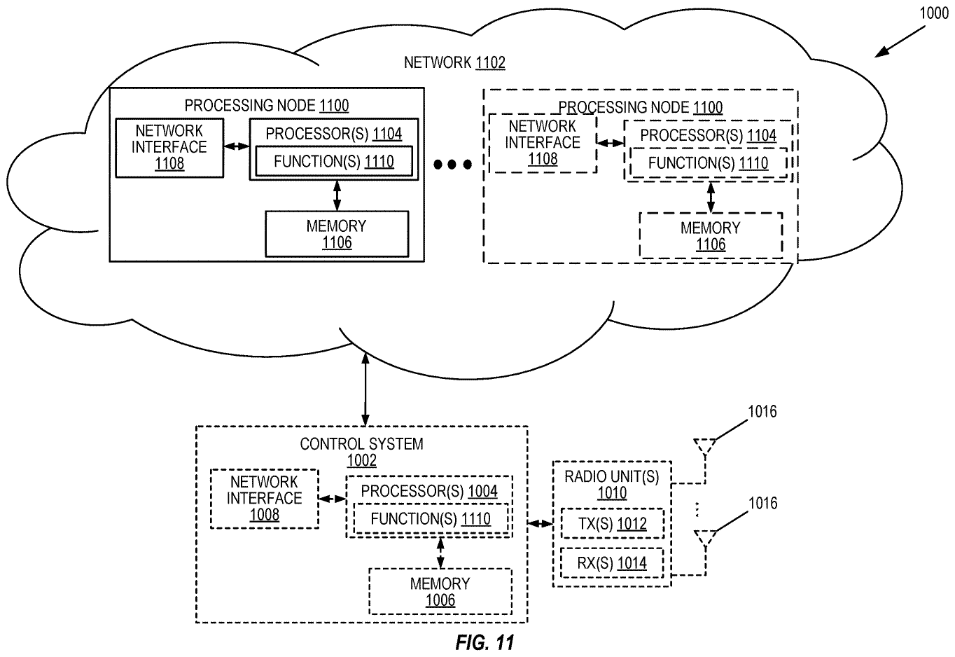

FIG. 11 is a schematic block diagram that illustrates a virtualized embodiment of the network node 1000 according to some embodiments of the present disclosure. Again, optional features are represented by dashed boxes. As used herein, a “virtualized” network node is an implementation of the network node 1000 in which at least a portion of the functionality of the network node 1000 is implemented as a virtual component(s) (e.g., via a virtual machine(s) executing on a physical processing node(s) in a network(s)). As illustrated, in this example, if the network node 1000 is a radio access node, the network node 1000 may include the control system 1002 and/or the one or more radio units 1010, as described above. The control system 1002 may be connected to the radio unit(s) 1010 via, for example, an optical cable or the like. The network node 1000 includes one or more processing nodes 1100 coupled to or included as part of a network(s) 1102. If present, the control system 1002 or the radio unit(s) are connected to the processing node(s) 1100 via the network 1102. Each processing node 1100 includes one or more processors 1104 (e.g., CPUs, ASICs, FPGAs, and/or the like), memory 1106, and a network interface 1108.

In this example, functions 1110 of the network node 1000 described herein (e.g., one or more functions of a base station 702 or gNB described herein) are implemented at the one or more processing nodes 1100 or distributed across the one or more processing nodes 1100 and the control system 1002 and/or the radio unit(s) 1010 in any desired manner. In some particular embodiments, some or all of the functions 1110 of the network node 1000 described herein are implemented as virtual components executed by one or more virtual machines implemented in a virtual environment(s) hosted by the processing node(s) 1100. As will be appreciated by one of ordinary skill in the art, additional signaling or communication between the processing node(s) 1100 and the control system 1002 is used in order to carry out at least some of the desired functions 1110. Notably, in some embodiments, the control system 1002 may not be included, in which case the radio unit(s) 1010 communicate directly with the processing node(s) 1100 via an appropriate network interface(s).

In some embodiments, a computer program including instructions which, when executed by at least one processor, causes the at least one processor to carry out the functionality of the network node 1000 or a node (e.g., a processing node 1100) implementing one or more of the functions 1110 of the network node 1000 in a virtual environment according to any of the embodiments described herein is provided. In some embodiments, a carrier comprising the aforementioned computer program product is provided. The carrier is one of an electronic signal, an optical signal, a radio signal, or a computer readable storage medium (e.g., a non-transitory computer readable medium such as memory).

FIG. 12 is a schematic block diagram of the network node 1000 according to some other embodiments of the present disclosure. The network node 1000 includes one or more modules 1200, each of which is implemented in software. The module(s) 1200 provide the functionality of the network node 1000 described herein. This discussion is equally applicable to the processing node 1100 of FIG. 11 where the modules 1200 may be implemented at one of the processing nodes 1100 or distributed across multiple processing nodes 1100 and/or distributed across the processing node(s) 1100 and the control system 1002.

Any appropriate steps, methods, features, functions, or benefits disclosed herein may be performed through one or more functional units or modules of one or more virtual apparatuses. Each virtual apparatus may comprise a number of these functional units. These functional units may be implemented via processing circuitry, which may include one or more microprocessor or microcontrollers, as well as other digital hardware, which may include Digital Signal Processor (DSPs), special-purpose digital logic, and the like. The processing circuitry may be configured to execute program code stored in memory, which may include one or several types of memory such as Read Only Memory (ROM), Random Access Memory (RAM), cache memory, flash memory devices, optical storage devices, etc. Program code stored in memory includes program instructions for executing one or more telecommunications and/or data communications protocols as well as instructions for carrying out one or more of the techniques described herein. In some implementations, the processing circuitry may be used to cause the respective functional unit to perform corresponding functions according to one or more embodiments of the present disclosure.

While processes in the figures may show a particular order of operations performed by certain embodiments of the present disclosure, it should be understood that such order is exemplary (e.g., alternative embodiments may perform the operations in a different order, combine certain operations, overlap certain operations, etc.).

Various embodiments of the present disclosure include the following embodiments.
Embodiment 1: A method performed by a Wireline Access Gateway Function, W-AGF, (110) for handling registration and connection of Authenticable Non-Third Generation Partnership Program, 3GPP, AUN3, devices with a core network, the method comprising: receiving (202) a registration request from a device comprising at least one of a Fifth Generation Residential Gateway, 5G-RG, (104) or an AUN3 device (102); determining (204) whether a registered and connected 5G-RG (104) is associated with a connection on which the registration request is received; and performing (206, 208) a network operation based on a result of the determining.
Embodiment 2: The method of embodiment 1, wherein the determining whether a registered and connected 5G-RG (104) is associated with the connection is based on determining that a Level Wireline Access Characteristic, LWAC, parameter, associated with the registration request exists in the subscription data.
Embodiment 3: The method of embodiment 1, wherein the determining whether a registered and connected 5G-RG (104) is associated with the connection is based on an indication of a device type in the registration request indicating whether the device is the 5G-RG (104) or the AUN3 device (102).
Embodiment 4: The method of any of embodiments 1 to 3, wherein in response to determining there is no connected 5G-RG (104) associated with the registration request and there is no LWAC parameter in the subscription data, the performing the network operation comprises: rejecting (208) the registration request.
Embodiment 5: The method of any of embodiments 1 to 3, wherein in response to determining there is a registered and connected 5G-RG (104) associated with the registration request, the performing the network operation comprises: forwarding (206) the registration request to an Access and Mobility Function, AMF, (108) in the core network.
Embodiment 6: The method of embodiment 5, wherein the forwarding comprises forwarding the registration request with an N2 parameter indicating there is a registered and connected 5G-RG (104).
Embodiment 7: The method of any of embodiments 1 to 6, further comprising: receiving (302) a release request associated with a 5G-RG(104); determining (304) whether a registered and connected AUN3 device (102) is associated with a connection on which the deregistration request is received; and performing (306) a second network operation based on a result of the determining.
Embodiment 8: The method of embodiment 7, wherein in response to determining there is no registered and connected 5G-RG (104) device associated with the release request, the performing the second network operation comprises: sending (306) a release request to the AMF (108) with an indication that there is no connected 5G-RG (104) associated with the deregistration request.
Embodiment 9: The method of embodiment 7, wherein in response to determining there is no connected 5G-RG (104) associated with the release request, the performing the second network operation comprises: releasing (502) the AUN3 device (102).
Embodiment 10: The method of any of embodiments 1 to 9, further comprising: receiving (402) a service request associated with an AUN3 device (102); determining (404) whether a registered and connected 5G-RG (104) is associated with a connection on which the service request is received; and performing (406) a third network operation based on a result of the determining.
Embodiment 11: The method of embodiment 10, wherein in response to determining there is a connected 5G-RG (104) associated with the service request, the performing the third network operation comprises: forwarding (406) the service request to the AMF (108) with an indication that there is a registered and connected 5G-RG (104) associated with the service request.
Embodiment 12: The method of embodiment 10, wherein in response to determining there is no connected 5G-RG (104) associated with the service request, the performing the third network operation comprises: reject (408) the service request the AUN3 device (102).
Embodiment 13: A Wireline Access Gateway Function, W-AGF, (110) configured for handling registration of Authenticable Non-Third Generation Partnership Program, 3GPP, AUN3, devices with a core network, the W-AGF (110) comprising processing circuitry configured to: receive (202) a registration request from a device comprising at least one of a Fifth Generation Residential Gateway, 5G-RG, (104) or an AUN3 device (102); determine (204) whether a registered and connected 5G-RG (104) is associated with a connection on which the registration request is received; and perform (206, 208) a network operation based on a result of the determining.
Embodiment 14: The W-AGF (110) of embodiment 13, wherein the processing circuitry is further configured to perform any of embodiments 2-12.
Embodiment 15: A method performed by an Access and Mobility Function, AMF, (108) of a core network for handling registration of Authenticable Non-Third Generation Partnership Program, 3GPP, AUN3, devices, the method comprising: receiving (206), from a Wireline Access Gateway Function, W-AGF, (110) a registration request from a device comprising at least one of a Fifth Generation Residential Gateway, 5G-RG, (104) or an AUN3 device (102); in response to the registration request comprising an indication that there is a registered gateway already connected, accepting (210) the registration request; and in response to the registration request not comprising an indication that there is a registered and connected gateway already connected, rejecting (208) the registration request in response to the registration request not corresponding to a 5G-RG (104).
Embodiment 16: The method of embodiment 15, wherein the accepting the registration request or rejecting the registration request is based on whether subscription data corresponding to the registration request comprises a parameter associated with the 5G-RG (104).
Embodiment 17: The method of embodiment 16, wherein the parameter is a Level Wireline Access Characteristic, LWAC, parameter.
Embodiment 18: The method of embodiment 15, wherein the accepting the registration request or rejecting the registration request is based on an indication of a device type indicating whether the registration request is from a 5G-RG (104) or an AUN3 device (102).
Embodiment 19: The method of any of embodiments 15 to 18, further comprising: receiving (306) a release request associated with an AUN3 device (102) that indicates that an associated registered 5G-RG (104) has been disconnected; and deregistering (308) the AUN3 device (102).
Embodiment 20: An Access and Mobility Function, AMF, (108) configured for handling registration of Authenticable Non-Third Generation Partnership Program, 3GPP, AUN3, devices with a core network, the AMF (108) comprising processing circuitry configured to: receive (206), from a Wireline Access Gateway Function, W-AGF, (110) a registration request from a device comprising at least one of a Fifth Generation Residential Gateway, 5G-RG, (104) or an AUN3 device (102); in response to the registration request comprising an indication that there is a registered gateway already connected, accept (210) the registration request; and in response to the registration request not comprising an indication that there is a registered and connected gateway already connected, reject (208) the registration request in response to the registration request not corresponding to a 5G-RG (104).
Embodiment 21: The AMF (108) of embodiment 20, wherein the processing circuitry is further configured to perform embodiments 16 to 19.

1. A method performed by a Wireline Access Gateway Function (W-AGF), for handling registration and connection to a core network of one or more Authenticable Non-Third Generation Partnership Program (3GPP) (AUN3) devices behind a residential gateway (RG) connected with a line to the W-AGF, the method comprising:
receiving from the line connected to the RG a registration request to register an AUN3 device behind the RG; and
transmitting to the core network a message comprising the received registration request to register the AUN3 device behind the RG and an indication indicating whether there is an existing N2 connection to the core network for the RG connected to the line on which the registration request is received.

2. The method of claim 1, further comprising:
receiving from the core network a request to release a context associated with the RG;
identifying one or more AUN3 devices behind the RG that are connected to the core network; and
for each of the one or more AUN3 devices, sending to the core network a release message to release a context associated with the corresponding AUN3 device and wherein the release message includes an indication that the release message is due to disconnection of the RG.

3. The method of claim 1, further comprising:
determining that there is an existing N2 connection to the core network for the RG connected to the line on which the registration request is received is based on determining that a Level Wireline Access Characteristic (LWAC) parameter associated with the registration request exists in the subscription data.

4. The method of claim 1, further comprising:
determining that there is an existing N2 connection to the core network for the RG connected to the line on which the registration request is received based on an indication of a device type in the registration request indicating whether the device is the RG or the AUN3 device.

5. The method of claim 1, wherein the transmitting to the core network comprises transmitting the registration request to an Access and Mobility Function (AMF) in the core network.

6. The method of claim 5, wherein the transmitting comprises transmitting the registration request with an N2 parameter indicating there is a registered and connected RG.

7. The method of claim 1, further comprising:
receiving a service request associated with an AUN3 device;
determining whether a registered and connected RG is associated with a connection on which the service request is received; and
performing a network operation based on a result of the determining.

8. The method of claim 7, wherein in response to determining there is a connected RG associated with the service request, the performing the network operation comprises:
forwarding the service request to the AMF with an indication that there is a registered and connected RG associated with the service request.

9. The method of claim 7, wherein in response to determining there is no connected RG associated with the service request, the performing the network operation comprises:
rejecting the service request associated with the AUN3 device.

10. A Wireline Access Gateway Function (W-AGF) configured for handling registration and connection of Authenticable Non-Third Generation Partnership Program (3GPP) (AUN3) devices with a core network, the W-AGF comprising processing circuitry configured to cause the W-AGF to:
receive from the line connected to a residential gateway (RG) a registration request to register an AUN3 device behind the RG; and
transmit to the core network a message comprising the received registration request to register the AUN3 device behind the RG and an indication indicating whether there is an existing N2 connection to the core network for the RG connected to the line on which the registration request is received.

11. The W-AGF of claim 10, wherein the processing circuitry is further configured to cause the W-AGF to:
receive from the core network a request to release a context associated with the RG;
identify one or more AUN3 devices behind the RG that are connected to the core network; and
for each of the one or more AUN3 devices, send to the core network a release message to release a context associated with the corresponding AUN3 device and wherein the release message includes an indication that the release message is due to disconnection of the RG.

12. The W-AGF of claim 10, wherein the processing circuitry is further configured to cause the W-AGF to:
determine that there is an existing N2 connection to the core network for the RG connected to the line on which the registration request is received is based on determining that a Level Wireline Access Characteristic (LWAC) parameter, associated with the registration request exists in the subscription data.

13. The W-AGF of claim 10, wherein the processing circuitry is further configured to cause the W-AGF to:
determine that there is an existing N2 connection to the core network for the RG connected to the line on which the registration request is received based on an indication of a device type in the registration request indicating whether the device is the RG or the AUN3 device.

14. The W-AGF of claim 10, wherein the transmitting to the core network comprises transmitting the registration request to an Access and Mobility Function (AMF) in the core network.

15. The W-AGF of claim 14, wherein the transmitting comprises transmitting the registration request with an N2 parameter indicating there is a registered and connected RG.

16. The W-AGF of claim 10, wherein the processing circuitry is further configured to cause the W-AGF to:
receive a service request associated with an AUN3 device;
determine whether a registered and connected RG is associated with a connection on which the service request is received; and
perform a network operation based on a result of the determining.

17. The W-AGF of claim 16, wherein in response to determining there is a connected RG associated with the service request, the performing the network operation comprises:
forwarding the service request to the AMF with an indication that there is a registered and connected RG associated with the service request.

18. The W-AGF of claim 16, wherein in response to determining there is no connected RG associated with the service request, the performing the network operation comprises:
rejecting the service request associated with the AUN3 device.

19. A method performed by an Access and Mobility Function (AMF) of a core network for handling registration of one or more Authenticable Non-Third Generation Partnership Program (3GPP) (AUN3) devices behind a residential gateway (RG) connected with a line to a Wireline Access Gateway Function (W-AGF), the method comprising:
receiving, from the W-AGF, a message comprising a registration request to register an AUN3 device behind the RG and an indication indicating whether there is an existing N2 connection to the core network for the RG connected to the line on which the registration request is received at the W-AGF; and
in response to determining based on the indication that there is no existing N2 connection for the RG connected to the line on which the registration request is received at the W-AGF, rejecting the registration request of the AUN3 device.

20. The method of claim 19, further comprising:
receiving for each registered one or more AUN3 devices behind the RG a release message to release a context associated with the corresponding AUN3 device and wherein the release message includes an indication that the release message is due to disconnection of the RG; and
initiating deregistration of each of the registered one or more AUN3 devices.

21. An Access and Mobility Function (AMF) of a core network for handling registration of one or more Authenticable Non-Third Generation Partnership Program (3GPP) (AUN3) devices behind a residential gateway (RG) connected with a line to a Wireline Access Gateway Function (W-AGF), wherein the AMF comprises processing circuitry that causes the AMF to:
receive, from the W-AGF, a message comprising a registration request to register an AUN3 device device behind the RG and an indication indicating whether there is an existing N2 connection to the core network for the RG connected to the line on which the registration request is received at the W-AGF; and
in response to determining based on the indication that there is no existing N2 connection for the RG connected to the line on which the registration request is received at the W-AGF, reject the registration request of the AUN3 device.

22. The AMF of claim 21, wherein the processing circuitry is further configured to cause the AMF to:
receive for each registered one or more AUN3 devices behind the RG a release message to release a context associated with the corresponding AUN3 device and wherein the release message includes an indication that the release message is due to disconnection of the RG; and
initiate deregistration of each of the registered one or more AUN3 devices.
